(19) United States
(12) Patent Application Publication
(10) Pub. No.: US 2008/0158135 A1
(43) Pub. Date: Jul. 3, 2008

(54) BACKLIGHT ASSEMBLY, METHOD OF DRIVING THE SAME, AND LIQUID CRYSTAL DISPLAY HAVING THE SAME

(76) Inventors: Sang Jun Lee, Wando-Gun (KR); Sung Hee Lee, Yongin-Si (KR)

Correspondence Address: F. CHAU & ASSOCIATES, LLC, 130 WOODBURY ROAD, WOODBURY, NY, 11797, US

(21) Appl. No.: 11/931,402

(22) Filed: Oct. 31, 2007

(30) Foreign Application Priority Data
Dec. 28, 2006 (KR) 10-2006-0136667

(51) Int. Cl. H05B 41/36; G09G 3/36

(52) U.S. Cl. 345/102; 315/154

(57) ABSTRACT

A backlight assembly, a method of driving the same, and a liquid crystal display (LCD) having the same includes a backlight assembly having first and second lamps, a power source for providing power, a sensor for outputting a sensing signal in accordance with the ambient luminance, a power controller for changing the level of the output power of the power source to provide the changed output power to the second lamp in response to the sensing signal, a feedback signal generator for generating a feedback signal as the power of the power source is supplied to the second lamp, and a power converter for providing the power of the power source to the first lamp or changing the level of the output power of the power source to provide the changed output power to the first lamp.

### CROSS-REFERENCE TO RELATED PATENT APPLICATION

This application claims priority to Korean Patent Application No. 2006-0136667, filed on Dec. 28, 2006, in the Korean Intellectual Property Office, the disclosure of which is incorporated by reference herein.

### BACKGROUND OF THE INVENTION

1. Technical Field

The present disclosure relates to a backlight assembly, a method of driving the same, and a liquid crystal display having the same and, more particularly, to a backlight assembly, wherein a plurality of light sources of the backlight assembly are turned on or off in accordance with ambient brightness to control the brightness of a screen, thereby extending the life span of the light sources of the backlight assembly.

2. Discussion of Related Art

Because a liquid crystal display (LCD) is a light receiving device that is not self-luminescent, the LCD requires a backlight assembly for providing an LCD panel with light from below the LCD panel. Such a backlight assembly generally requires characteristics of high luminance, high efficiency, and uniformity of luminance, long life span, slimness, light weight, a low price, and the like. For example, in case of backlights employed in notebook computers or small-sized electronic devices, slim and highly efficient lamps are required. In case of LCDs for monitors or TVs, lamps with high luminance and high uniformity of luminance are required.

Such backlight assemblies are divided into an edge type and a direct type depending on the position of the actual light source. Among these backlight assemblies, an edge-type backlight assembly includes a light guide plate provided below an LCD panel, and a lamp that is a light source that is positioned at one edge of the light guide plate. Accordingly, the light from the lamp can be uniformly radiated onto the entire LCD panel through the light guide plate.

Recently, it has been proposed to have two lamps positioned one above another at one edge of a light guide plate and controlled to be tuned on or off in accordance with the ambient brightness. That is, in a case where the ambient brightness is dark, only the upper lamp is driven. In a case where the ambient brightness is bright, the lower lamp is additionally driven. Accordingly, the brightness of the screen of the LCD is controlled in accordance with the ambient brightness, thereby preventing the user's eyes from being dazzled by a too bright screen in a dark room.

In a case where the lamps are driven as described above, the upper lamp should be continuously turned on regardless of the ambient brightness. Therefore, there is a problem in that the life span of the upper lamp is reduced.

### SUMMARY OF THE INVENTION

An exemplary embodiment of the present invention provides a backlight assembly, wherein the amount of power applied to an upper lamp is controlled in accordance with the ambient brightness, so as to extend the life span of the upper lamp, a method of driving the backlight assembly, and a liquid crystal display having the backlight assembly.

An exemplary embodiment of the present invention provides a backlight assembly including first and second lamps, a power source for providing power to the lamps, a sensor for outputting a sensing signal in accordance with the ambient luminance, a power controller for changing the level of the output power of the power source to provide the changed output power to the second lamp in response to the sensing signal, a feedback signal generator for generating a feedback signal as the power of the power source is supplied to the second lamp, and a power converter for providing the power of the power source to the first lamp or changing the level of the output power of the power source to provide the changed output power to the first lamp.

The power source may have a first power source for supplying power to the power converter and a second power source for supplying power to the power controller in response to a comparison signal, and the backlight assembly may further include a comparator for outputting the comparison signal if the voltage level of a reference voltage is higher than that of the sensing signal.

The feedback signal generator may generate the feedback signal in accordance with the output of the second power source. The voltage level of the reference voltage may be 0.3 to 0.7 if the maximum voltage level of the sensing signal is 1. The backlight assembly may further include a switch for providing the power of the second power source to the power controller in response to the comparison signal.

The power controller may have a PWM (Pulse Width Modulation) circuit.

The output power of the power controller may vary within the maximum output power of the power converter.

The current level of power lowered by the power converter may be 0.1 to 0.5 if the current level of power provided to the power converter is 1.

The backlight assembly may further include a switch for providing the power of the power source to the power controller in response to the sensing signal.

The backlight assembly may further include a first transformer provided between the power converter and the first lamp, and a second transformer provided between the power controller and the second lamp.

An exemplary embodiment of the present invention provides a backlight assembly including first and second lamps, a power source for providing power, a sensor for outputting a sensing signal in accordance with the ambient luminance, a power controller for changing the level of the output power of the power source to provide the changed output power to the second lamp in response to the sensing signal, a switch for providing the power of the power source to the power controller and generating a feedback signal, in response to the sensing signal, and a power converter for providing the power of the power source to the first lamp or changing the level of the output power of the power source to provide the changed output power to the first lamp.

The backlight assembly may further include a comparator for outputting a comparison signal if the voltage level of a reference voltage is higher than that of the sensing signal, the comparison signal allowing the switch to be driven.

An exemplary embodiment of the present invention provides a backlight assembly including first and second lamps, a power source for providing power, a sensor for outputting a sensing signal in accordance with the ambient luminance, a first power controller for changing the level of the output power of the power source to provide the changed output power to the first lamp in response to the sensing signal, and a second power controller for changing the level of the output power of the power source to provide the changed output power to the second lamp in response to the sensing signal.

The sensor may include a first sensor for applying a first sensing signal to the first power controller, and a second sensor for applying a second sensing signal to the second power controller.

The power source may have a first power source for supplying power to the first power controller and a second power source driven in response to a comparison signal so as to supply power to the second power controller, and the backlight assembly may further include a comparator for outputting the comparison signal if the voltage level of a reference voltage is higher than that of the sensing signal.

An exemplary embodiment of the present invention provides a liquid crystal display (LCD) including (i) a backlight assembly including first and second lamps for generating light in response to input power, a power source for providing power, a sensor for outputting a sensing signal in accordance with the ambient luminance, a power controller for changing the level of the output power of the power source to provide the changed output power to the second lamp in response to the sensing signal, a feedback signal generator for generating a feedback signal as the power of the power source is supplied to the second lamp, and a power converter for providing the power of the power source to the first lamp or changing the level of the output power of the power source to provide the changed output power to the first lamp; and (ii) an LCD panel for displaying images using light supplied from the backlight assembly.

An exemplary embodiment of the present invention provides a method of driving a backlight assembly, including: applying a first power to a first lamp so that the first lamp emits light; detecting the ambient luminance; and applying variable power to a second lamp in accordance with results of the detection of the ambient luminance so that the second lamp emits light, and applying a second power with a current level lower than that of the first power to the first lamp so that the first lamp emits light.

Applying the second power with the current level lower than that of the first power to the first lamp, so that the first lamp emits light; generating a feedback signal in accordance with the variable power applied to the second lamp; and applying the second power to the first lamp in response to the feedback signal.

An exemplary embodiment of the present invention provides a method of driving a backlight assembly, including detecting the ambient luminance; if it is determined from results of the detection of the ambient luminance that the ambient luminance is equal to or less than a reference level, applying a first variable power to a first lamp in accordance with the results of the detection of the ambient luminance, so that the first lamp emits light; and if it is determined from results of the detection of the ambient luminance that the ambient luminance is greater than the reference level, applying fixed power to the first lamp and applying a second variable power to a second lamp in accordance with the results of the detection of the ambient luminance, so that the second lamp emits light.

Power changing rates of the first and second variable powers may be identical with each other, and the maximum variable power level changed through the first variable power and the power level of the fixed power may be identical with each other.

### BRIEF DESCRIPTION OF THE DRAWINGS

Exemplary embodiments of the present invention can be understood in more detail from the following descriptions taken in conjunction with the accompanying drawings, in which:

FIG. 1 is an exploded perspective view of a liquid crystal display (LCD) according to an exemplary embodiment of the present invention;

FIG. 2 is a sectional view conceptually showing the LCD of the exemplary embodiment of FIG. 1 after it has been assembled;

FIG. 3 is a block diagram of a lamp driving module in the exemplary embodiment of the present invention;

FIG. 4 is a graph illustrating an operation of a lamp unit in the exemplary embodiment of the present invention;

FIGS. 5 and 6 are views conceptually illustrating an operation of a power controller according to the exemplary embodiment of the present invention;

FIG. 7 is a graph illustrating a change in the life span of a lamp in accordance with an applied current;

FIG. 8 is a block diagram of a lamp driving module in an LCD according to an exemplary embodiment of the present invention;

FIG. 9 is a block diagram of a lamp driving module in an LCD according to an exemplary embodiment of the present invention; and

FIG. 10 is a graph illustrating an operation of a lamp unit in an exemplary embodiment of the present invention.

### DETAILED DESCRIPTION OF EXEMPLARY EMBODIMENTS

Hereinafter, exemplary embodiments of the present invention will be described in detail with reference to the accompanying drawings. The present invention is not limited to the exemplary embodiments, however, but may be implemented in different forms. These exemplary embodiments are provided only for illustrative purposes and for full understanding of the scope of the present invention by those skilled in the art.

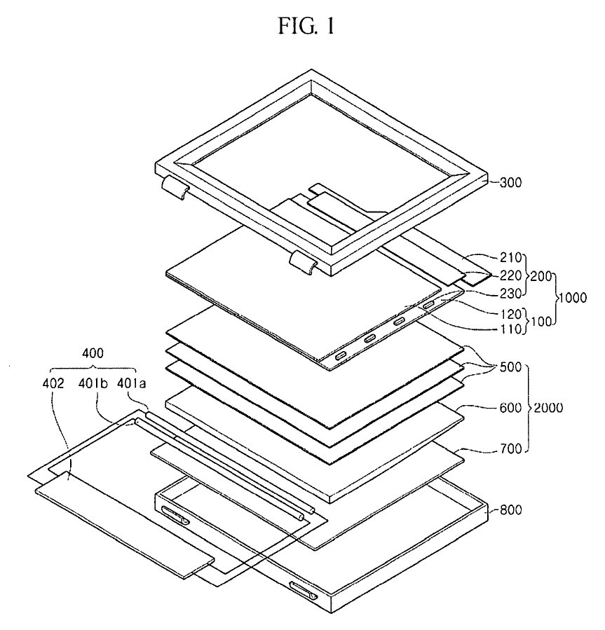

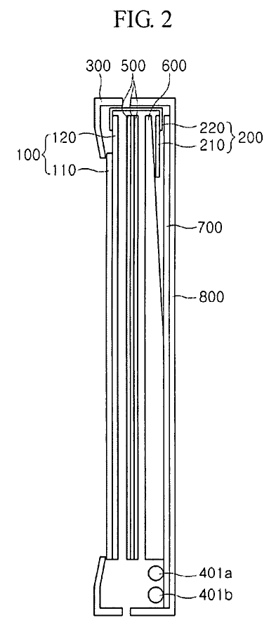

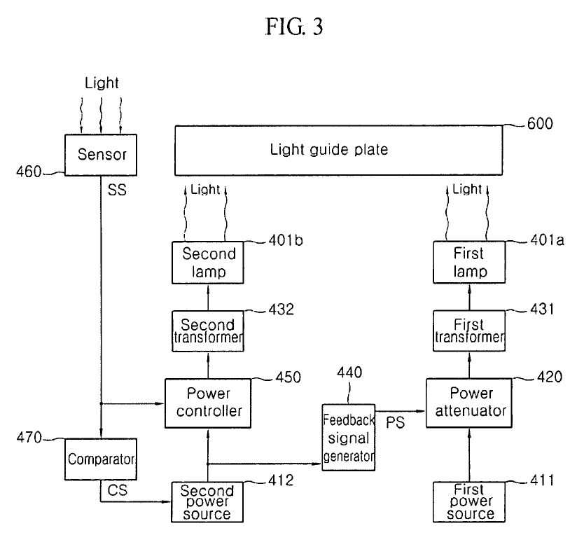

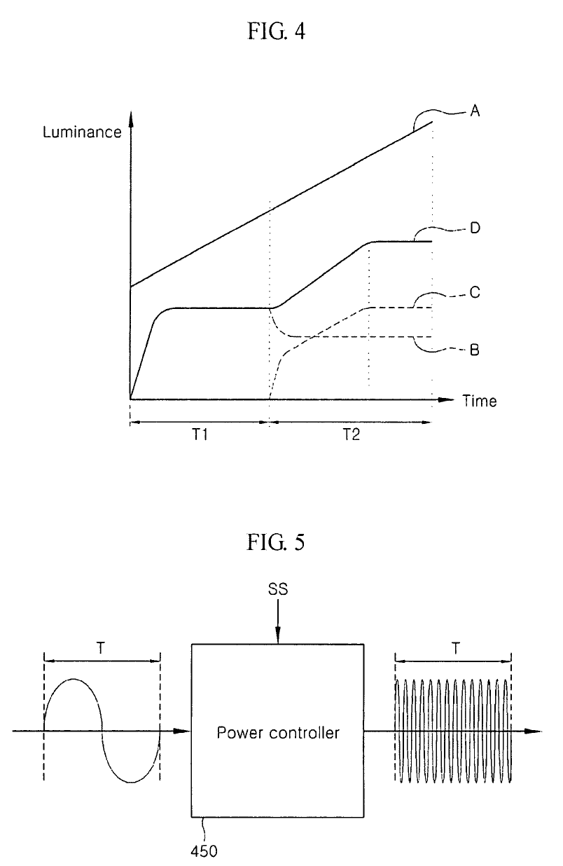

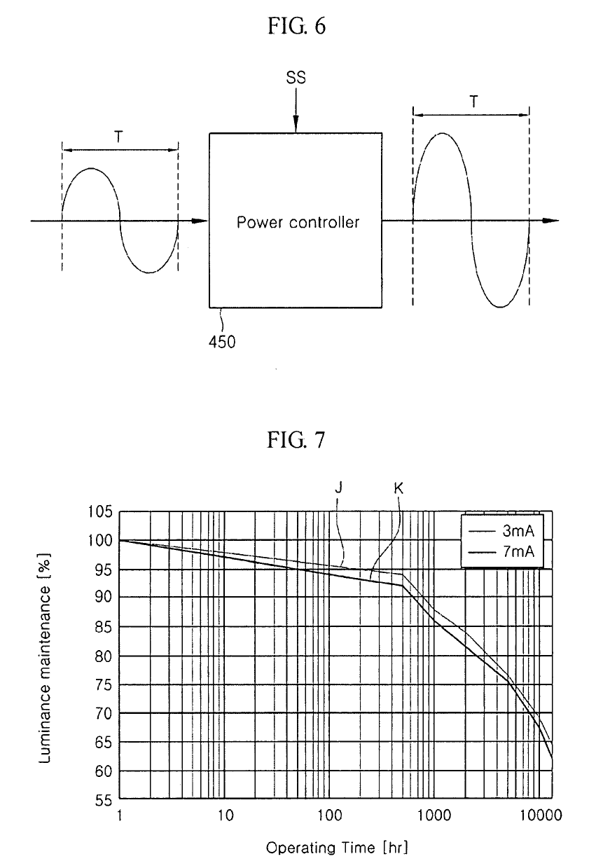

FIG. 1 is an exploded perspective view of a liquid crystal display (LCD) according to an exemplary embodiment of the present invention; FIG. 2 is a sectional view conceptually showing the LCD of the exemplary embodiment after it has been assembled; FIG. 3 is a block diagram of a lamp driving module in the exemplary embodiment of the present invention of FIG. 1; FIG. 4 is a graph illustrating an operation of a lamp unit in the exemplary embodiment of the present invention of FIG. 1; FIGS. 5 and 6 are views conceptually illustrating an operation of a power controller according to the exemplary embodiment of the present invention; and FIG. 7 is a graph illustrating a change in the life span of a lamp in accordance with an applied current.

Referring to FIGS. 1 to 6, the LCD according to this exemplary embodiment includes a display assembly 1000 and a backlight assembly 2000.

The display assembly 1000 includes an LCD panel 100 and a driving circuit unit 200.

The LCD panel 100 includes a common electrode substrate 110, a thin film transistor (TFT) substrate 120 and liquid crystals (not shown) interposed between the common electrode substrate 110 and the TFT substrate 120.

The common electrode substrate 110 is formed with red, green and blue color filters (not shown) that are color pixels for expressing predetermined colors while light passes through the pixels. A common electrode made of a transparent conductive material, such as indium tin oxide (ITO) or indium zinc oxide (IZO), is applied to the entire surface of the common electrode substrate 110. The TFT substrate 120 includes a plurality of gate lines and a plurality of data lines which intersect each other; and TFTs (not shown) are provided at respective intersection regions of the gate and data lines. A source terminal of each of the TFTs is connected to the data line, and a gate terminal of the TFT is connected to the gate line. Further, a drain terminal of the TFT is connected to the pixel electrode.

An operation of the LCD panel 100 constructed as above will be discussed below. Gate turn-on voltages are applied to the gate lines, and pixel voltages are applied to the data lines. Accordingly, pixel electrodes of the TFT substrate 120 are charged with the pixel voltage. When the pixel electrodes are charged with the respective pixel voltages, electric fields between the pixel electrodes and the common electrode are changed. The alignment of the liquid crystals provided between the pixel electrodes and the common electrode is changed depending on changes in the electric fields, and the transmittance of light is changed depending on the changed alignment of the liquid crystals, thereby obtaining a desired image.

The driving circuit unit 200 connected to the LCD panel 100 includes gate driving chip portions 230 for applying gate signals to the gate lines of the TFT substrate 120, and a printed circuit board (PCB) 210 connected to the LCD panel 100 through a flexible PCB 220.

The gate driving chip portions 230 are mounted on one edge of the TFT substrate 120 of the LCD panel 100. Although not shovel in the drawings, a data driver for applying data signals to the data lines of the TFT substrate 120, and a signal controller for controlling the gate driving chip portions 230 and the data driver are provided on the PCB 210. It will be apparent that this exemplary embodiment is not limited thereto but may further include a PCB with an additional gate driver for applying gate signals to the gate lines. At this time, the PCB with the gate driver is connected to the gate lines of the LCD panel 100 through a flexible PCB. Further, the gate driving chip portions 230 may not be mounted in a chip type on the LCD panel but may be manufactured in a stage type at one side of the LCD panel 100 together with the TFTs.

An upper receiving member 300 is provided above the display assembly 1000. The upper receiving member 300 prevents the components of the display assembly 1000 from coining off and simultaneously protects the LCD panel 100 that may be easily broken due to external impact. Further, although not shown in the drawings, an additional support frame for supporting the LCD panel 100 may be further provided in the upper receiving member 300.

The backlight assembly 2000 further includes a lamp unit 400 having a plurality of lamps 401a and 401b; a light guide plate 600 positioned to be adjacent the lamps of the lamp unit 400; a reflection plate 700 provided below the light guide plate 600; and a plurality of optical sheets 500 mounted above the light guide plate 600.

The light guide plate 600 converts light having an optical distribution of a line light source, which is emitted from the lamp unit 400, into light having all optical distribution of a surface light source. A wedge-type plate or parallel surface flat plate may be used as the light guide plate 600. Further, it is preferred that the light guide plate 600 be generally formed of PMMA (polymethylmethacrylate) that is not easily deformed and broken because of its high strength and that has superior light transmittance.

A plate with a high optical reflectivity is used as the reflection plate 700 in order to reduce light loss by re-reflecting the light, which is incident on the reflection plate through a rear surface of the light guide plate 600, toward the light guide plate 600.

The plurality of optical sheets 500 includes a diffusion sheet, a polarization sheet and a luminance enhancement sheet. The plurality of optical sheets 500 are positioned above the light guide plate 600 to make the luminance distribution of light radiated from the light guide plate 600 uniform.

The lamp unit 400 includes the first and second lamps 401a and 401b, and a lamp driving module 402 for applying power to the first and second lamps 401a and 401b.

The first and second lamps 401a and 401b are arranged in a fore and aft or up and down direction with respect to one side surface of the light guide plate 600. That is, as shown in FIG. 2, the first lamp 401a is positioned to be adjacent one edge surface of the light guide plate 600, and the second lamp 401b is positioned to be adjacent the first lamp 401a, while being spaced apart from the light guide plate 600. In other words, the first and second lamps 401a and 401b are arranged in a fore and aft direction oil an extension line extending perpendicularly from the edge surface of the light guide plate 600. It will be apparent that the first and second lamps 401a and 401b need not be arranged on such an extension line. That is, the first and second lamps 401a and 401b may be arranged above and below with respect to the extension line. Accordingly, it is possible to minimize interruption of light emitted from the second lamp 401b by the first lamp 401a. The arrangement of the first and second lamps 401a and 401b is not limited thereto but may vary depending on the thickness of the light guide plate 600 and the thickness of each of the first and second lamps 401a and 401b. For example, in a case where the thickness of the light guide plate 600 is identical with that of each of the first and second lamps 401a and 401b, it is preferred that the first and second lamps 401a and 401b be sequentially arranged at the one edge surface of the light guide plate 600 as described above. On the other hand, in a case where the thickness of the light guide plate 600 is larger than that of each of the first and second lamps 401a and 401b, both the first and second lamps 401a and 401b may be arranged to be adjacent the one edge surface of the light guide plate 600. That is, both the first and second lamps 401a and 401b may be arranged to be spaced apart by an identical distance from the edge surface of the light guide plate 600. Further, the lamp unit 400 may be provided with more than two lamps. In addition, although not shown in the drawings, the lamp unit 400 may further include a lamp clamp that surrounds the first and second lamps 401a and 401b and has a reflective surface on an inner surface of the lamp clamp. The lamp clamp can reflect light of the first and second lamps 401a and 401b toward the light guide plate 600, resulting in maximized use efficiency.

The lamp driving module 402 adjusts the luminance of the first lamp 401a and controls the driving and luminance of the second lamp 401b in accordance with the external luminance (brightness). Accordingly, the luminance of the backlight assembly 2000 can be adjusted in accordance with the external luminance.

To this end, as shown in FIG. 3, the lamp driving module 402 includes a first power source 411 for supplying power; a power attenuator 420 for lowering the power level of the first power source 411 in response to a feedback signal PS; a first transformer 431 for transforming the output of the power attenuator 420 to provide the transformed output to the first lamp 401a; a second power source 412 for supplying power in response to a comparison signal CS; a feedback signal generator 440 for generating the feedback signal PS in response to the output power of the second power source 412; a power controller 450 for converting the amplitude and/or frequency of the power of the second power source 412 in response to a sensing signal SS; a second transformer 432 for transforming the output of the power controller 450 to provide the transformed output to the second lamp 401b; a sensor 460 for providing the sensing signal SS in accordance with external brightness; and a comparator 470 for generating the comparison signal CS in response to the sensing signal SS.

The first power source 411 receives externally supplied power and then outputs AC power. The first power source 411 has an inverter (not shown) for converting high-voltage DC power supplied from an external system into AC power. A Royer inverter, a push-pull inverter, a half-bridge inverter, a full-bridge inverter or the like may be used as the inverter.

In the case where the feedback signal PS is not applied, the power attenuator 420 provides the AC power of the first power source 411 to the first transformer 431. In the case where the feedback signal PS is applied, the power attenuator 420 changes the level of the AC power of the first power source 411 and provides the first transformer 431 with the power in which the level has been changed. That is, the power attenuator 420 preferably lowers the level and provides the first transformer 431 with the power of which the level has been lowered. To this end, although not shown in the drawings, the power attenuator 420 has a wiring portion for providing the AC power of the first power-source 411 directly to the first transformer 431; a switch connected to the wiring portion and driven in response to the feedback signal PS; and a current attenuating means connected to the switch to form an additional current path. In the case where the feedback signal PS is not applied, the AC power of the first power source 411 is transmitted directly to the first transformer 431 through the wiring portion as it is. On the other hand, in the case where the feedback signal PS is applied, the switch is operated such that a part of a current of the AC power of the first power source 411 flows through the current attenuating means, thereby lowering the level of the AC power of the first power source 411. At this time, if the current level of the AC power of the first power source 411 is set to be 1, it is preferred that a current lowered by the power attenuator 420 be 0.1 to 0.5. That is, the current level of the AC power provided to the first transformer 431 through the power attenuator 420 upon application of the feedback signal PS is preferably 0.5 to 0.9. For example, in a case where the current level of the AC power, which is the output of the first power source 411, is 6 mA, the current level of the lowered AC power that is output through first power attenuator 420 is preferably 3 to 5 mA. In this exemplary embodiment, because the power attenuator 420 is not manufactured in the form of an additional chip but manufactured using only one switch and a current path as described above, manufacturing costs of the backlight assembly 200 can be reduced.

The first transformer 431 transforms the AC power applied through the power attenuator 420 into a voltage with a corresponding amplitude based on a winding ratio and then provides the transformed voltage to the first lamp 401a. The first transformer 431 has a primary coil connected to the power attenuator 420 and a secondary coil connected to the first lamp 401a.

The second power source 412 is operated in response to the comparison signal CS to receive externally supplied power and to output AC power. The second power source 412 includes an inverter for converting high-voltage AC power supplied from an external system (not shown) into AC power, and a switch for outputting AC power that is the output of the inverter in response to the comparison signal CS. It will be apparent that the second power source 412 is not limited thereto but may include an inverter for converting high-voltage DC power supplied from an external system into AC power while being operated in response to the comparison signal CS.

The feedback signal generator 440 generates the feedback signal PS in response to the output of the second power source 412. That is, in a case where there is no output from the second power source 412, the feedback signal generator 440 does not generate the feedback signal PS. In a case where the second power source 412 outputs AC power, the feedback signal generator 440 generates the feedback signal PS to provide it to the power attenuator 420.

The power controller 450 converts the amplitude and/or frequency of the power of the second power source 412 and provides the converted power to the second transformer 432 in response to the sensing signal SS. In an exemplary embodiment, an IC chip having a PWM (Pulse Width Modulation) circuit is used as the power controller 450. As shown in FIG. 5, the power controller 450 has a frequency conversion module (not shown) for converting the frequency of the AC power of the second power source 412 so as to output the converted AC power in response to the sensing signal SS. Further, the power controller 450 has an amplitude conversion module (not shown) for converting the amplitude of the AC power of the second power source 412 so as to output the converted AC power in response to the sensing signal SS, as shown in FIG. 6.

The power controller 450 may variously change the voltage and current levels of the AC power supplied to the second transformer 432 by changing the amplitude and/or frequency of the AC power of the second power source 412 in response to the sensing signal SS. At this time, if the voltage and current levels of maximum AC power provided to the first transformer 431 is set to be 1, the output of the power controller 450 preferably varies within a range of 0 to 1. For example, in a case where the voltage of the sensing signal SS varies from 0 to 2V, if the sensing signal SS of 0V is applied to the power controller 450, the power controller 450 does not output AC power. Meanwhile, if the sensing signal SS of 2V is applied to the power controller 450, the power controller 450 changes the AC power of the second power source 412 so as to output AC power that has been changed to the same level as the maximum AC power provided to the first transformer 431. In a case where a maximum current provided to the first lamp 401a through the first transformer 431 is 6 mA, it is preferred that a current provided to the second lamp 401b through the second transformer 432 be 0 to 6 mA. This is because the power consumption rating of the first lamp 401a is identical with that of the second lamp 401b. It will be apparent that, in a case where the power consumption rating of the first lamp 401a is different from that of the second lamp 401b, the output range of the power controller 450 may be larger or smaller than that described above.

The second transformer 432 transforms the AC power applied through the power controller 450 into a voltage with a corresponding amplitude based on a winding ratio and then provides the transformed AC power to the second lamp 401b. The second transformer 432 has a primary coil connected to the power controller 450 and a secondary coil connected to the second lamp 401b.

The sensor 460 outputs a sensing signal SS in which the voltage level is changed depending on the ambient brightness. Although not shown in the drawings, the sensor 460 includes a sensing portion for sensing external light; an amplification portion for amplifying an output of the sensing portion; and a signal conversion portion for converting an output of the amplifier into a voltage level and outputting the converted voltage level. A photo diode in which the amount of current varies depending on the intensity (quantity/luminance) of external light is used as the sensing portion. Accordingly, as the intensity of the external light increases, the output current of the sensing portion increases and, thus, the voltage range of the sensing signal SS, which is an output of the signal converter, is expanded. In an exemplary embodiment, it is preferred that the voltage range of the sensing signal SS in the sensor 460 be 0 to 2V. The sensor 460 may be positioned in a light transmitting groove (not shown) provided in the upper receiving member 300 shown in FIG. 1. An ambient light sensor (ALS) may be used as the sensor 460.

The comparator 470 compares the voltage level of the sensing signal SS with a reference voltage level. If the voltage level of the sensing signal SS is larger than the reference voltage level, the comparator 470 generates a comparison signal CS. At this time, if the maximum voltage level of the sensing signal SS is 1, the reference voltage level may be 0.3 to 0.7. The reference voltage level could also be 0.4 to 0.6. At this time, if the reference voltage level is lower than the aforementioned range, the second lamp 410b emits light in an interval with low ambient luminance. Therefore, there may be a problem in that the luminance of the LCD panel 100 rapidly increases. In the case where the reference voltage level is higher than the aforementioned range, this corresponds to a state where the ambient luminance is high. Because the second lamp 401b does not emit light, however, there may be a problem in that the visibility of an image on the LCD panel 100 is degraded.

Hereinafter, the operation of the lamp unit 400 according to this exemplary embodiment will be described with reference to FIG. 4. In this exemplary embodiment, A in FIG. 4 is a solid line indicating an imaginary ambient luminance around the LCD, B is a dotted line indicating the luminance of the first lamp 401a, C is a dotted line indicating the luminance of the second lamp 401b, and D is a solid line indicating the overall luminance of the lamp unit 400.

First, in an interval with low external luminance (interval T1 in FIG. 4), the first lamp 401a emits light by means of AC power that is the output of the first power source 411. Because the external luminance is low, however, the sensing signal SS that is the output of the sensor 460 has a voltage level lower than the reference voltage of the comparator 470. Thus, because the comparator 470 does not output a comparison signal CS, the second power source 412 does not output AC power. Accordingly, the second lamp 401b does not emit light.

Therefore, the luminance of the lamp unit 400 is identical with that of the first is lamp 401a in the interval with low external luminance, as shown in FIG. 4. As shown in FIG. 4, the luminance of the first lamp 401 rapidly increases in an initial stage of application of the power of the first power source 411 and is then maintained at a certain value after lapse of a certain period of time (saturation).

Subsequently, in a time interval with high external luminance (interval T2 in FIG. 4), the second power source 412, as well as the first power source 411, outputs AC power. That is, because the external luminance is high, the sensing signal SS, which is the output of the sensor 460, has a voltage level higher than the reference voltage of the comparator 470. Thus, the comparator 470 outputs a comparison signal CS to drive the second power source 412, and the second power source 412 outputs AC power. At this time, the power controller 450 changes the AC power of the second power source 412 according to the voltage level of the sensing signal SS and provides the changed AC power to the second lamp 401b. Thus, the level of the changed AC power provided to the second lamp 401b varies depending on the external brightness detected by the sensor 460. Therefore, the luminance of the second lamp 401b varies depending, on the external luminance. That is, as the external luminance increases, the light emitting luminance of the second lamp 401b also increases. The feedback signal generator 440 supplies a feedback signal PS to the power attenuator 420 by means of the AC power of the second power source 412. Accordingly, the power attenuator 420 lowers the current level of the AC power of the first power source 411 and provides the first lamp 401a with the AC power having the lowered current level. Thus, the luminance of the first lamp 401a decreases.

Therefore, the luminance of the lamp unit 400 is identical with a value obtained by adding the luminance of the first lamp 401a to that of the second lamp 401b in the interval with high external luminance. At this time, as shown in FIG. 4, when the changed AC power is initially supplied to the second lamp 401b through the power controller 450, the luminance of the second lamp 401b rapidly increases. Subsequently, if external luminance increases, the current level of the changed AC power supplied to the second lamp 401b through the power controller 450 gradually increases. Therefore, the luminance of the second lamp 401b also gradually increases. Thereafter, the changed AC power supplied to the second lamp 401b through the power controller 450 is saturated, and the luminance of the second lamp 401b is also saturated. Further, the luminance of the first lamp 401a is gently decreased and then saturated after a lapse of a certain period of time.

The aforementioned lamp driving will be further described below by way of example. Before a description thereof, external power supplied from an external system is provided to the LCD panel 100 and the backlight assembly 2000 when the LCD is driven. At this time, the external power provided to the backlight assembly 2000 is provided to the first and second power sources 411 and 412 of the lamp unit 400. In an exemplary embodiment, the power provided from the external system is high-voltage DC power that in turn is provided after being converted into AC power by the first and second power sources 411 and 412.

In an exemplary embodiment, the first power source 411 outputs a current of 6 mA, and the sensor 460 outputs a sensing signal SS with a voltage level of 0 to 2V in accordance with the detected external luminance. A description will be made below in connection with a case where the reference voltage of the comparator 470 is set to 1. Hereinafter, it is assumed that the first and second transformers 431 and 432 do not change the output currents of the power attenuator 420 and the power controller 450.

First, if the voltage level of the sensing signal SS of the sensor 460 is lower than 1V because the ambient luminance around the LCD is low, the comparator 470 does not output a comparison signal CS. Accordingly, the second power source 412 does not output AC power and, thus, the feedback signal generator 440 also does not generate a feedback signal PS. The second lamp 401b is not operated. Further, the power attenuator 420 does not change the output of the first power source 411 but outputs the output of the first power source 411 as it is. Thus, a current of 6 mA that is the output of the first power source 411 is provided to the first lamp 401a through the power attenuator 420 and the first transformer 431. The first lamp 401a emits light with a luminance corresponding to 6 mA. The level of the current provided to the lamp is in proportion to the brightness (luminance) of the lamp.

Accordingly, the lamp unit 400 provides light with a luminance corresponding to 6 mA to the light guide plate 600.

Then, if the voltage level of the sensing signal SS of the sensor 460 becomes 1V because the ambient luminance around the LCD increases, the comparator 470 generates a comparison signal CS and provides it to the second power source 412. The second power source 412 outputs AC power in response to the comparison signal CS. The power controller 450 changes the AC power of the second power source 412 in accordance with the voltage level (1V) of the sensing signal SS and provides the changed AC power to the second lamp 401b. A current provided to the second lamp 401b becomes 3 mA. The second lamp 401b emits light with a luminance corresponding to 3 mA. The feedback signal generator 440 generates a feedback signal PS and provides it to the power attenuator 420 in response to the AC power of the second power source 412. In response to the feedback signal PS, the power attenuator 420 lowers the current of 6 mA, which is the output of the first power source 420, and provides the lowered current to the first lamp 401a. In an exemplary embodiment, the current provided to the first lamp 401a is 4 mA. The first lamp 401a emits light with a luminance corresponding to 4 mA.

Accordingly, the lamp unit 400 provides light with a luminance corresponding to 7 mA to the light guide plate 600.

Then, if the voltage level of the sensing signal SS of the sensor 460 becomes 1V or more but below 2V as the ambient luminance around the LCD gradually increases, the power controller 450 changes the AC power of the second power source 412 and provides the changed AC power to the second lamp 401b in response to the voltage level of the sensing signal SS. At this time, a current of 3 mA or more but below 6 mA is provided to the second lamp 401b. The second lamp 401b emits light with a luminance corresponding to the current of 3 mA or more but below 6 mA. At this time, the first lamp 401a continuously emits light with luminance corresponding to 4 mA.

Accordingly, the lamp unit 400 provides light with luminance corresponding to 7 mA to 10 mA to the light guide plate 600.

Because the voltage level of the sensing signal SS of the sensor 460 is maintained at 2V, even though the ambient luminance around the LCD further increases, the second lamp 401b emits light with a luminance corresponding to a current of 6 mA. Accordingly, the lamp unit 400 continuously provides the luminance corresponding to a current of 10 mA to the light guide plate 600.

According to the LCD of this exemplary embodiment described above, when the ambient luminance around the LCD is low, only the luminance of the first lamp 401a in the lamp unit 400 is used to display images oil the LCD panel 100. Further, when the ambient luminance around the LCD is high, the luminance of the first lamp 401a in the lamp unit 400 is decreased and the second lamp 401b is simultaneously caused to emit light so that the reduced luminance of the first lamp 401a and the luminance of the second lamp 401b can be used to display images on the LCD panel 100. At this time, while the luminance of the first lamp 401a is decreased, the luminance of the second lamp 401b increases. Accordingly, the luminance of light emitted from the lamp unit 400 increases.

Because the luminance of the light emitted from the lamp unit 400 varies depending on the ambient brightness around the LCD, it is possible to prevent a user's eyes from being dazzled due to the LCD panel 100. Further, since the level of a current applied to the first lamp 401a is reduced in an environment with high ambient luminance, the life span of the first lamp 401a can be extended. This is because the life span of the lamp is in inverse proportion to the level of the current applied to a lamp.

FIG. 7 is a graph showing measurements of a luminance maintenance rate in accordance with a lamp operating time when currents of 3 mA and 7 mA are continuously applied to a lamp. J in FIG. 7 is a line indicating results upon application of a current of 3 mA to a lamp, and K is a line indicating luminance results upon the application of a current of 7 m to a lamp. In an exemplary embodiment, assuming that the limit of the life span of a lamp is a case where the luminance maintenance rate of the lamp is 70%, the life span of the lamp is about 8,000 hours upon application of a current of 7 mA to a lamp (J) but about 9,500 hours upon application of a current of 3 mA a lamp (K). As such, the life span of the lamp can be extended as the level of the current applied to a lamp becomes lower. Accordingly, the life span of the first lamp 401a can be extended by decreasing the current applied to the first lamp 401a in an environment with a high ambient luminance, as described above.

The backlight assembly 200 in this exemplary embodiment may further include a rectifying unit (not shown) for converting AC power supplied from the outside into high-voltage DC power. A diode rectifier or active PWM rectifier may be used as the rectifying unit.

In an exemplary embodiment cold cathode fluorescent lamps (CCFLs) are used as the first and second lamps 401a and 401b that are the light sources in the lamp unit 400 in this exemplary embodiment. This exemplary embodiment is not limited thereto, however. That is, a plurality of LED devices may be used as the light source in the lamp unit 400. In other words, a lamp with a plurality of LED devices mounted on a bar-shaped substrate may be used as each of the first and second lamps 401a and 401b. Further, although the edge-type backlight assembly 2000 has been employed in the exemplary embodiment described above, the present invention is not limited thereto but may also be applied to a direct-type backlight assembly in which a plurality of first and second lamps 401a and 401b are arranged below the LCD panel 100 and spaced apart from one another at predetermined intervals.

As shown in FIG. 1, the above-described backlight assembly 2000 is accommodated within a receiving space of a lower receiving member 800. The lower receiving member 800 includes a bottom surface and side walls extending to protrude vertically from respective edges of the bottom surface. An additional mold frame (not shown) for supporting the backlight assembly 2000 may be further provided in the lower receiving member 800.

The lamp driving module of the LCD according to exemplary embodiments of the present invention is not limited to the foregoing but may drive the first and second lamps through a single power source. Hereinafter, a lamp driving module of a display device according to an exemplary embodiment of the present invention will be described.

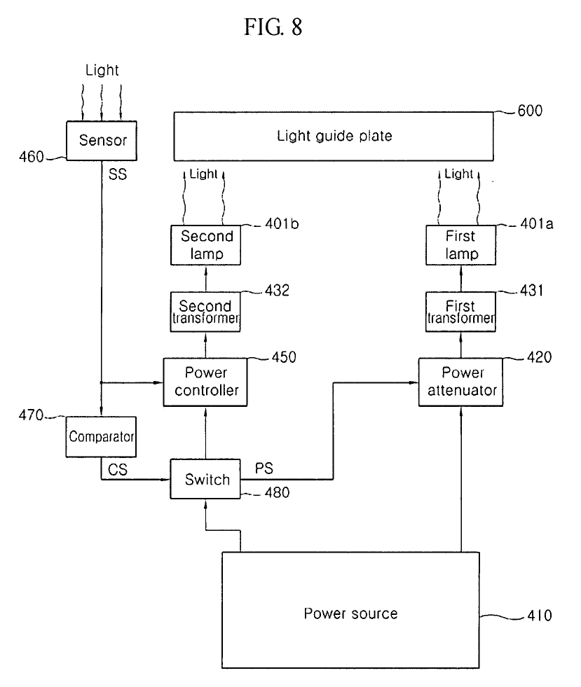

Descriptions overlapping with those of the exemplary embodiment described above will be omitted. Further, descriptions of the exemplary embodiment of FIG. 8 may also be applied to the exemplary embodiment of FIG. 3.

FIG. 8 is a block diagram of a lamp driving module in an LCD according to an exemplary embodiment of the present invention;.

As shown in FIG. 8, the lamp driving module 402 in this exemplary embodiment has a single power source 410 and a switch 480 operated in response to a comparison signal CS of the comparator 470. The switch 480 supplies an output of the power source 410 to the power controller 450 and provides a feedback signal PS to the power attenuator 420, in response to the comparison signal CS.

The single power source 410 simultaneously supplies AC power to the power attenuator 420 and the switch 480. In this exemplary embodiment, the AC power supplied to each of the power attenuator 420 and the switch 480 through the single power source 410 has the same level. It will be understood, however, that power with different levels may be supplied. If a comparison signal CS is not applied, the switch 480 prevents the AC power of the power source 410 from being supplied to the power controller 450 and does not generate a feedback signal PS. If the feedback signal PS is not applied, the power attenuator 420 supplies the AC power of the power source 410 to a first lamp 401a, so that the first lamp 401a emits light. If a comparison signal CS is applied, the switch 480 supplies the AC power of the power source 410 to the power controller 450 and simultaneously generates a feedback signal PS and provides it to the power attenuator 420. The power controller 450 receiving the AC power changes the amplitude and/or frequency of the AC power in response to the sensing signal SS from the sensor 460. Further, the power controller 450 provides the changed AC power to a second lamp 401b, so that the second lamp 401b emits light. If the feedback signal PS is applied, the power attenuator 420 lowers the current level of the AC power of the power source 410. Further, the power attenuator 420 supplies the AC power with the lowered current level to the first lamp 401a, so that the first lamp 401a emits light.

As such, the first and second lamps 401a and 401b can emit light through the single power source 410 in this exemplary embodiment. The switch 480 driven in response to a comparison signal CS is provided so that the supply of power to the power controller 450 can be controlled. The feedback signal PS is generated to lower the current level of the AC power supplied to the first lamp 401a when the second lamp 401b emits light, thereby extending the life span of the first lamp 401a.

In an exemplary embodiment, the switch 480 itself may not generate a feedback signal PS, and a feedback signal generator 440 for supplying the feedback signal PS to the power attenuator 420 in response to the output of the switch 480 may be further provided as described in the exemplary embodiment shown in FIG. 3. Further, the aforementioned switch 480 may be positioned between the power controller 450 and the second power source 412 described in the exemplary embodiment shown in FIG. 3. Furthermore, the switch 480 may be directly operated in response to the sensing signal SS.

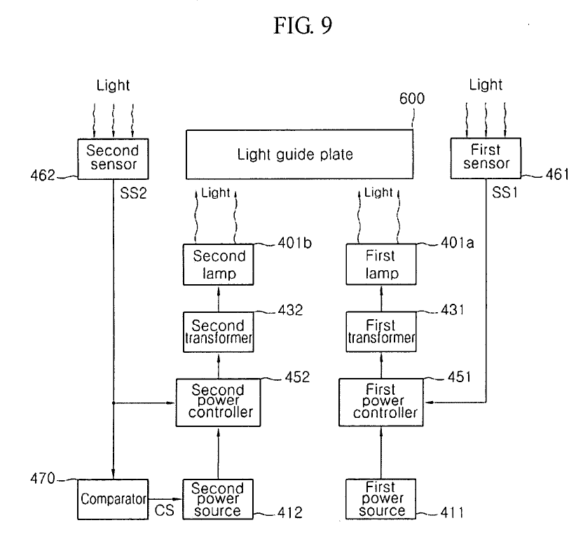

In addition, the lamp driving module of the LCD according to exemplary embodiments of the present invention is not limited to the foregoing but may further include a power controller capable of controlling the luminance of the first lamp in accordance with the detected ambient luminance. Hereinafter, a lamp driving module of a display device according to an exemplary embodiment of the present invention will be described. Descriptions overlapping with those of the exemplary embodiments of FIGS. 3 and 8 described above will be omitted. Further, the descriptions of the exemplary embodiment of FIG. 9 may be applied to the exemplary embodiments of FIGS. 3 and 8.

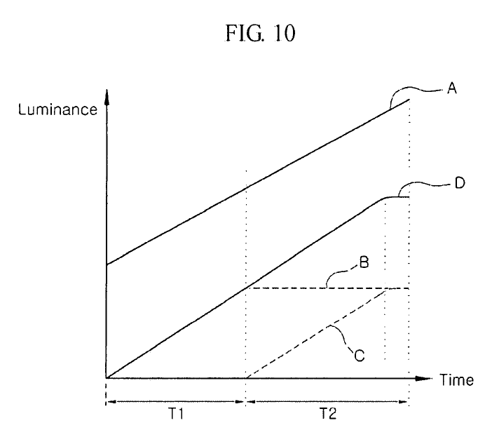

FIG. 9 is a block diagram of a lamp driving module in an LCD according to an exemplary embodiment of the present invention; and FIG. 10 is a graph illustrating an operation of a lamp unit in the exemplary embodiment of FIG. 9.

As shown in FIGS. 9 and 10, the lamp driving module 402 may have a first power controller 451 for changing the amplitude and/or frequency of output power of the first power source 411 in response to a first sensing signal SS1 from a first light sensor 461 to provide the changed output power to the first lamp 401a. According to this exemplary embodiment, a second power controller 452 for changing output power of the second power source 412 to provide the changed output power to the second lamp 401b is operated in response to a second sensing signal SS2 from a second sensor 462. In this manner, the luminance of each of the first and second lamps 401a and 401b can be controlled in accordance with the ambient luminance using the two, separate power controllers.

That is, the first and second sensors 461 and 462 respectively output first and second sensing signals SS1 and SS2 with low voltage levels in an interval with low ambient luminance (see interval T1 in FIG. 10). In response to the first sensing signal SS1 from the first sensor 461, the first power controller 451 changes the output power of the first power source 411 and provides the changed output power of the first power source 411 to the first lamp 401a so that the first lamp 401a emits light. As shown in FIG. 10, the luminance of the first lamp 401a increases as the ambient luminance increases. Further, the second sensing signal SS2 from the second sensor 462 is supplied to a comparator 470. Because the output voltage level of the second sensing signal SS2 is lower than the voltage level of a reference voltage of the comparator 470, however, the comparator 470 does not generate a comparison signal CS. Thus, the second power source 412 does not output power. As such, the overall luminance of the lamp unit 400 in an interval with low ambient luminance varies depending on the luminance of the first lamp 401a.

The first and second sensors 461 and 462 respectively output first and second sensing signals SS1 and SS2 with high voltage levels in an interval with high ambient luminance (see interval T2 in FIG. 10). If the voltage level of the first sensing signal SS1 of the first sensor 461 is equal to or greater than a certain level, the output power of the first power controller 451 becomes constant. Accordingly, the luminance of the first lamp 401a in the interval with high ambient luminance becomes constant as shown in FIG. 10. If a second sensing signal with a voltage level higher than the reference voltage of the comparator 470 is applied to the comparator 470, the comparator 470 applies a comparison signal CS to the second power source 412. The second power source 412 receiving the applied comparison signal CS provides AC power to the second power controller 452. In response to the voltage level of the second sensing signal SS2 of the second sensor 462, the second power controller 452 changes the amplitude and/or frequency of output power of the second power controller 452 and provides the changed output power to the second lamp 401b, so that the second lamp 401b emits light. That is, as the ambient luminance gradually increases in the interval with high ambient luminance, the voltage level of the second sensing signal SS2 increases. Accordingly, the light emitting luminance of the second lamp 401b also gradually increases. If the voltage level of the second sensing signal SS2 becomes a maximum value that can be output by the second sensor 462, the luminance of the second lamp 401b is saturated. As such, the luminance of the lamp unit 400 in the interval with high ambient luminance varies depending on the luminance of the first and second lamps 401a and 401b.

The changing rates of the power changed by the first and second power controllers 451 and 452 are identical with each other. Further, power with a constant level output through the first power controller 451 in the interval with high ambient luminance is preferably the maximum output power of the first power controller 451. It will be seen that the power with a constant level may be lower than the maximum output power of the first power controller 451 or may have the same level as the output power of the first power source 411.

In this exemplary embodiment, the voltage levels of the first and second sensing signals SS1 and SS2 of the first and second sensors 461 and 462 may be identical with each other. Also, an additional comparator (not shown) may be provided between the first sensor 461 and the first power controller 451 so that, if the voltage of the first sensing signal SS1 of the first sensor 461 is equal to or greater than a reference voltage, the reference voltage can be provided to the first power controller 451. Accordingly, even though the ambient luminance increases, the power output through the first power controller 451 may have a constant value. Of course, the present invention is not limited thereto, that is, the respective voltage levels of the first and second sensing signals SS1 and SS2 of the first and second sensors 461 and 462 may be different from each other. Further, the first and second power controllers 451 and 452 may be controlled using one sensor. Accordingly, in this variation, the luminance of the lamp unit 400 varies depending on the ambient luminance around the LCD, thereby preventing the user's eyes from being dazzled. Further, the amount of current applied to the first lamp 401a is variably supplied in accordance with the ambient luminance, thereby extending the life span of the first lamp 401a.

According to exemplary embodiments of the present invention described above, only a first lamp is driven if the ambient luminance is low, and a second lamp is additionally driven if the ambient luminance is high, so that the brightness of an LCD can be controlled in accordance with the ambient luminance.

Further, according to exemplary embodiments of the present invention, the amount of current applied to the first lamp is reduced when the second lamp is additionally driven, thereby extending the life span of the first lamp.

Although the present invention has been described in connection with the accompanying drawings and the exemplary embodiments, the present invention is not limited thereto but defined by the appended claims. Accordingly, it will be understood by those of ordinary skill in the art that various modifications and changes can be made thereto without departing from the spirit and scope of the invention defined by the appended claims.

What is claimed is:

1. A backlight assembly, comprising:
first and second lamps;
a power source for providing power;
a sensor for outputting a sensing signal in accordance with a sensed ambient luminance;
a power controller for changing a level of an output power of the power source to provide the changed output power to the second lamp in response to the sensing signal;
a feedback signal generator for generating a feedback signal as the power of the power source is supplied to the second lamp; and
a power converter for providing the power of the power source to the first lamp in a first mode and changing the level of the output power of the power source to provide the changed output power to the first lamp in a second mode.

2. The backlight assembly of claim 1, wherein the power source comprises a first power source for supplying power to the power converter and a second power source for supplying power to the power controller in response to a comparison signal, and the backlight assembly further comprises a comparator for outputting the comparison signal when the voltage level of a reference voltage is higher than a voltage level of the sensing signal.

3. The backlight assembly of claim 2, wherein the feedback signal generator generates the feedback signal in accordance with the output of the second power source.

4. The backlight assembly of claim 2, wherein the voltage level of the reference voltage is 0.3 to 0.7 if the maximum voltage level of the sensing signal is 1.

5. The backlight assembly of claim 2, further comprising a switch for providing the power of the second power source to the power controller in response to the comparison signal.

6. The backlight assembly of claim 1, wherein the power controller has a pulse width modulation circuit.

7. The backlight assembly of claim 1, wherein the output power of the power controller varies within the maximum output power of the power converter.

8. The backlight assembly of claim 1, wherein the level of power lowered by the power converter is 0.1 to 0.5 if the level of power provided to the power converter is 1.

9. The backlight assembly of claim 1, further comprising a switch for providing the power of the power source to the power controller in response to the sensing signal.

10. The backlight assembly of claim 1, further comprising:
a first transformer provided between the power converter and the first lamp; and
a second transformer provided between the power controller and the second lamp.

11. A backlight assembly, comprising:
first and second lamps;
a power source for providing power;
a sensor for outputting a sensing signal in accordance with a second ambient luminance;
a power controller for changing a level of an output power of the power source to provide the changed output power to the second lamp in response to the sensing signal;
a switch for providing the power of the power source to the power controller and generating a feedback signal in response to the sensing signal; and
a power converter for providing the power of the power source to the first lamp in a first mode or changing the level of the output power of the power source to provide the changed output power to the first lamp in a second mode.

12. The backlight assembly of claim 11, further comprising a comparator for outputting a comparison signal when the voltage level of a reference voltage is higher than a voltage level of the sensing signal, wherein the comparison signal causes the switch to be driven.

13. The backlight assembly of claim 11, wherein the power controller has a first power controller for changing a level of an output power of the power source to provide the changed output power to the first lamp in response to the sensing signal, and a second power controller for changing the level of the output power of the power source to provide the changed output power to the second lamp in response to the sensing signal.

14. The backlight assembly of claim 13, wherein the sensor comprises a first sensor for applying a first sensing signal to the first power controller, and a second sensor for applying a second sensing signal to the second power controller.

15. The backlight assembly of claim 13, wherein the power source comprises a first power source for supplying power to the first power controller and a second power source driven in response to a comparison signal so as to supply power to the second power controller, and the backlight assembly further comprises a comparator for outputting the comparison signal when the voltage level of a reference voltage is higher than a voltage level of the sensing signal.

16. A liquid crystal display (LCD), comprising:
(i) a backlight assembly including:
first and second lamps for generating light in response to input power,
a power source for providing power,
a sensor for outputting a sensing signal in accordance with a sensed ambient luminance,
a power controller for changing a level of an output power of the power source to provide the changed output power to the second lamp in response to the sensing signal,
a feedback signal generator for generating a feedback signal as the power of the power source is supplied to the second lamp, and
a power converter for providing the power of the power source to the first lamp in a first mode or changing the level of the output power of the power source to provide the changed output power to the first lamp in a second mode; and
(ii) an LCD panel for displaying images using light supplied from the backlight assembly.

17. A method of driving a backlight assembly, comprising:
applying a first power to a first lamp so that the first lamp emits light;
detecting an ambient luminance; and
applying a variable power to a second lamp in accordance with results of the detection of the ambient luminance so that the second lamp emits light, and applying a second power with a level lower than a level of the first power to the first lamp.

18. The method of claim 17, wherein the step of applying the second power with the current level lower than that of the first power to the first lamp comprises:
generating a feedback signal in accordance with the variable power applied to the second lamp; and
applying the second power to the first lamp in response to the feedback signal.

19. A method of driving a backlight assembly, comprising:
detecting an ambient luminance;
if it is determined from results of the detection of the ambient luminance that the ambient luminance is equal to or less than a reference level, applying a first variable power to a first lamp in accordance with the results of the detection of the ambient luminance so that the first lamp emits light; and
if it is determined from results of the detection of the ambient luminance that the ambient luminance is greater than the reference level, applying a fixed power to the first lamp and applying a second variable power to a second lamp in accordance with the results of the detection of the ambient luminance so that the second lamp emits light.

20. The method of claim 19, wherein power changing rates of the first and second variable powers are identical with each other, and the maximum variable power level changed through the first variable power and the power level of the fixed power are identical with each other.
